(19) United States
(12) Patent Application Publication
(10) Pub. No.: US 2023/0257627 A1
(43) Pub. Date: Aug. 17, 2023

(54) METHOD FOR FORMING RETARDATION OPTICAL FILM

(71) Applicant: CSI Chemical CO., LTD., Nantong City (CN)

(72) Inventors: CHI-YUNG TSENG, New Taipei City (TW); JIAN-MING CHIU, Chiayi County (TW); SHIU-HUI WANG, Taipei City (TW)

(21) Appl. No.: 17/748,011

(22) Filed: May 18, 2022

(30) Foreign Application Priority Data
Feb. 15, 2022 (CN) 202210136417.5

(51) Int. Cl. C09D 179/08

(52) U.S. Cl. CPC C09D 179/08

(57) ABSTRACT

A method for forming a retardation optical film is provided. The method includes: adding a diamine monomer (A) and a dianhydride monomer (A) in a solvent (A) to react to form a polyimide slurry; adding the polyimide slurry into a solvent (B) to precipitate out a plurality of polyimide fibers; washing the plurality of polyimide fibers with a solvent (C); mixing the plurality of polyimide fibers with a solvent (D) to obtain a soluble polyimide solution; reacting a diamine monomer (B) and a dianhydride monomer (B) to form a polyamic acid solution; coating a mixed solution including the soluble polyimide solution and the polyamic acid solution on a substrate; and heating to form a retardation optical film made of polyimide on the substrate.

### CROSS REFERENCE TO RELATED APPLICATION

The present application claims priority to CN Patent Application Serial No. 202210136417.5, filed on Feb. 15, 2022, which is hereby incorporated by reference in its entirety.

### FIELD

The present invention relates to methods for forming a retardation optical film, and in particular to methods for forming a low retardation optical film made of polyimide.

### BACKGROUND

Liquid crystal displays have increasingly harsh requirements for visibility (brighter, easier to identify, better contrast, higher viewing angle, etc.). However, if only the liquid crystal cell itself is improved, the demand for improving the visibility cannot be fully met. Therefore, it is relatively more dependent on improving the performance of the retardation optical film to improve visibility.

A retardation optical film is required to have the following characteristics: high transparency, low optical birefringence, heat resistance, light resistance, high surface hardness, high mechanical strength, the small wavelength dependence of retardation, small incident angle dependence of retardation, etc. When a polymer is used as a retardation optical film, it has optical anisotropy due to its own molecular structure arrangement and film-forming process. This phenomenon is a birefringence phenomenon caused by different optical refractive indices of different mediums so that when the light passes through the film, the path and characteristics of the light are affected, so the retardation value is generated. There are different requirements for this characteristic depending on the application field. In order to meet the application in various fields, adjusting the applicability of the optical anisotropy of polymer materials will be a key development project for polymers applied to optical material films.

When the polymer material is coated and baked, the density in the plane direction of the film and the direction of the longitudinal axis are different. The speed of the light passing through is also different, resulting in the difference of the optical refractive index in the plane direction of the film and the direction of the longitudinal axis so that the film has the optically anisotropic property. Among currently commercialized low retardation products, retardation optical films formed by cycloolefm polymer (COP) are the mainstream. Compared with commercial plastic substrates (such as PET), which have higher retardation (for example, the retardation value Rₜₕ is greater than 800 nm), COP is used to reduce the interference of the birefringence phenomenon on viewing angles. The stretching method enables the polymer molecular segments to reduce the interference of birefringence caused by their internal stress during baking. On the other hand, during the stretching process, the COP exhibits refractive index anisotropy in which the refractive index in the same direction is reduced and the refractive index in the straight direction is increased so the retardation value of the transparent optical film mainly based on the COP can be reduced.

In addition, when using a plastic substrate such as PET as the optical film in the display, in order to avoid the birefringence phenomenon, the retardation optical film needs to be made above the polarizer. The overall thickness of this display is not easy to reduce and its design will be limited. Currently, the mainstream of display structure design is to place an optical film with low retardation value (for example, COP) in the lower layer of the polarizer, and then integrate it into the display element. The integration process can reduce the use of optically clear adhesive (OCA). It can achieve the purpose of reducing its thickness. The design and application fields of flexible products can be expanded more widely.

### SUMMARY OF THE DISCLOSURE

One of the objects of the invention is to form a low retardation optical film made of polyimide to replace the above-mentioned optical film and a plastic substrate made of materials such as COP. Therefore, in a situation in which rainbow patterns caused by the birefringence phenomenon can be avoided, the retardation optical film is integrated under the polarizer (more specifically, between the polarizer and the display module) to form a thin and light display with excellent visibility.

In addition to the above-mentioned stretching methods and heating methods that affect the retardation value of the film, the molecular structure and dispersibility of the polymer itself are also the fundamental reasons for determining the retardation value. In the invention, low molecular weight, soluble and/or meta-position polyimide (Soluble Polyimide; SPI) is introduced into the polyamic acid (PAA) so that when the slurry mixed with each other is baked to form a film, the dispersibility of the molecular structure of the polyamic acid is randomly disturbed by the soluble polyimide, and the irregularity of the arrangement is increased. Therefore, the formed retardation optical film can have the desired low retardation value. The display including this retardation optical film can be prevented from the problem of rainbow patterns.

Accordingly, the invention provides a method for forming a retardation optical film. The method includes: adding a diamine monomer (A) and a dianhydride monomer (A) in a solvent (A) to react to form a polyimide slurry; adding the polyimide slurry into a solvent (B) to precipitate out a plurality of polyimide fibers; washing the plurality of polyimide fibers with a solvent (C); mixing the plurality of polyimide fibers with a solvent (D) to obtain a soluble polyimide solution; reacting a diamine monomer (B) and a dianhydride monomer (B) to form a polyamic acid solution; coating a mixed solution including the soluble polyimide solution and the polyamic acid solution on a substrate; and heating to form a retardation optical film made of polyimide on the substrate. Here, (A) in “diamine monomer (A)” and “dianhydride monomer (A)”, and (B) in “diamine monomer (B)” and “dianhydride monomer (B)” are mainly for the purpose of distinction. For example, “diamine monomer (A)” may also be referred to as the first diamine monomer. “Dianhydride monomer (A)” may also be referred to as the first dianhydride monomer. “Diamine monomer (B)” may also be referred to as a second diamine monomer. “Dianhydride monomer (B)” may also be referred to as a second dianhydride monomer.

### DETAILED DESCRIPTION

The following describes the implementation of the present disclosure by specific embodiments. Those skilled in the art understand other advantages and effects of the present disclosure from the content disclosed in this specification. The present disclosure can also be implemented or applied by other different specific embodiments. Various details in this specification can also be modified and changed based on different viewpoints and applications without departing from the spirit of the present invention. Unless the context dictates otherwise, the singular forms “a” and “the” used in the specification and the appended claims include plural referents. Unless the context dictates otherwise, the term “or” used in the specification and the appended claims includes the meaning of “and/or”.

The method for forming a retardation optical film according to the invention comprises the following steps (1) to (6):

Step (1): Under the environment of inert gas, diamine monomer (A) is added into a solvent (A), and the solvent (A) is stirred at room temperature (for example, 22° C.˜25° C., the same below) until the diamine monomer (A) is completely dissolved (for example, stirring for 30 minutes). The dianhydride monomer (A) and the solvent (A) are then added and keep being stirred at room temperature (for example, 30 minutes) for pre-polymerization. Next, the temperature is raised to an appropriate temperature to perform imidization, thereby forming a polyimide slurry.

In step (1), the inert gas comprises such as nitrogen, argon, and so on. Furthermore, the solvent (A) may be a polar solvent, a low boiling point solvent or a low water absorption solvent. For example, the solvent (A) may be at least one selected from a group consisting of m-Cresol, dimethylacetamide (DMAc), tetrahydrofuran (THF), N-methyl-2-pyrrolidone (NMP), N, N-Dimethylformamide (DMF), dimethylsulfoxide (DMSO), chloroform, 3-methoxy-N, N-dimethylpropionamide and γ-butyrolactone (GBL), but it is not limited thereto. One of them may be used alone or two or more of them may be used in combination according to requirements. The amount of solvent (A) is not particularly limited.

In one embodiment, the diamine monomer (A) comprises at least one selected from a group consisting of 3,4′-diaminodiphenyl ether (ODA) and 4,4′-bis(3-aminophenoxy) diphenyl sulfone (Bis[4-(3-aminophenoxy)phenyl]Sulfone; m-BAPS), but it is not limited thereto. For example, in another embodiment, the diamine monomer (A) may be one or more selected from a group consisting of ODA, m-BAPS, 2,2′-bis(trifluoromethyl)benzidine (TFMB), 4,4′-diaminodiphenyl ether, 4,4′-diaminodicyclohexylmethane, 4,4′-Methylenebis(2-methylcyclohexylamine), 4,4′-(hexafluoroisopropylidene) bis(p-phenyleneoxy)dianiline and 3,3′-dimethylbenzidine. Furthermore, in one embodiment, the diamine monomer (A) is a meta-dianhydride monomer, such as ODA, m-BAPS, or other meta-position dianhydride monomers.

In one embodiment, the dianhydride monomer (A) comprises one or more selected from a group consisting of 1,2,4,5-cyclohexanetetracarboxylic acid dianhydride (HPMDA) and 3-(Carboxymethyl)-1,2,4-cyclopentanetricarboxylic acid 1,4:2, 3-dianhydride (TCA), but it is not limited thereto. For example, in another embodiment, the dianhydride monomer (A) may be one or more selected from a group consisting of 1,2,4,5-cyclohexanetetracarboxylic acid dianhydride (HPMDA), tetrahydro-5,9-methano-1H-pyrano[3,4-D]oxazepine-1,3,6,8(4H)-tetraketone (TCA), 4,4′-(hexafluoroisopropylidene)diphthalic anhydride (6FDA), 4,4-oxydiphthalic anhydride (ODPA) and cyclobutane-1,2,3,4-tetracarboxylicdianhydride (CBDA).

For the imidization method of the diamine monomer (A) and the dianhydride monomer (A) in the solvent (A), an appropriate imidization method, such as a thermal imidization method, a chemical imidization method or an imidization method combined the thermal imidization method and the chemical imidization method, can be chosen. For example, in an embodiment of the thermal imidization method, the temperature is raised to about 180° C. and the stirring continues for 12 to 24 hours so that the pre-polymer is forcibly dehydrated and condensed to form polyimide. On the other hand, the chemical imidization method is to add a dehydrating agent and/or a catalyst to form a polyimide. In one embodiment, the chemical imidization method is carried out at 80˜460° C. The dehydrating agent is acetic anhydride or other suitable dehydrating agents. The catalyst is isoquinoline, triethylamine (TEA), β-picolyl, pyridine, or other suitable catalysts, but it is not limited thereto. In one embodiment, the amount of the added dehydrating agent and/or catalyst is at least twice that of the diamine monomer (A) and the dianhydride monomer (A), so as to facilitate the completion of the reaction.

Step (2): The polyimide slurry obtained in step (1) has a higher viscosity due to high-temperature reaction. Therefore, after reducing the temperature to room temperature, the solvent (A) is added for dilution and keeps being stirred. Next, the diluted polyimide slurry is added into a solvent (B). Since the solubility of the polyimide slurry itself is not high, when the low-polarity solvent (B) is gradually dripped, it will precipitate to form long strips of fine polyimide fibers, and the solvent (A) is dissolved in the solvent (B). Then, using the Soxhlet extraction method, the polyimide fibers are washed with solvent (C) to remove the residual solvent (A) inside the polyimide fibers, and finally dried at a suitable high temperature in a vacuum environment.

In step (2), the diluted polyimide slurry is added into the solvent (B) using a plastic pipette or other suitable apparatus. Furthermore, in one embodiment, the diameter of the polyimide fiber dripped in the solvent (B) is 0.01˜0.05 cm, for example, about 0.03 cm, but it is not limited thereto.

In one embodiment, the solvent (A) becomes dark brown after being reacted at high temperature and oxidized. After adding the diluted polyimide slurry into the solvent (B), since the solvent (A) is dissolved in the solvent (B), the polyimide slurry and the precipitated polyimide fibers are discolored, for example, from dark brown to off-white. However, if there is the solvent (A) remaining, it will affect the color of the retardation optical film formed later. Therefore, the solvent (C) is used to clean the polyimide fibers so that the color of the polyimide fibers is changed from off-white to light white. It can prevent the reduction of the transparency of the retardation optical film, but it is not limited thereto. For example, in another embodiment, the solvent (A) is still colorless and transparent even after a high-temperature reaction.

In one embodiment, the solvent (B) and the solvent (C) are low-polarity solvents such as methanol, ethanol, water, and so on. In one embodiment, the material of the solvent (C) is the same as that of the solvent (B), for example, both the solvent (B) and the solvent (C) are methanol with strong permeability. The amount of solvent (B) and solvent (C) is not specifically limited.

Step (3): After adding the dried polyimide fibers into the solvent (D), it is filtered using filter paper, centrifugation, or other suitable methods so as to obtain a soluble polyimide solution. In one embodiment, since the solvent (D) is transparent and colorless, and the polyimide fibers washed by the solvent (C) are also close to white, the obtained soluble polyimide solution is clear and transparent. It is facilitated to subsequently form a transparent retardation optical film.

In step (3), the solubility of the solvent (D) is lower than that of the solvent (A). For example, in one embodiment, the solvent (D) is a low-solubility solvent such as tetrahydrofuran, ethyl acetate, and so on, while the solvent (A) is m-cresol solvent. The solvent (D) with low solubility is used so that the dried polyimide fibers are not completely dissolved in the solvent (D), but only the polyimide fibers with small molecular weight are selectively dissolved, thereby obtaining a soluble polyimide solution with low molecular weight. In one embodiment, filter paper is used to filter out polyimide fibers with a molecular weight greater than 100,000 (for example, about 100,000˜200,000), while the molecular weight of the polyimide fibers dissolved in the soluble polyimide solution is less than 100,000 (for example, 10,000˜50,000 is preferred).

Step (4): Under the environment of inert gas, the diamine monomer (B) is added into the solvent (E), and the solvent (E) is stirred at room temperature until the diamine monomer (B) is completely dissolved. The dianhydride monomer (B) is then added, and the solvent (E) keeps being stirred at room temperature to carry out a polymerization reaction so as to form a polyamic acid solution, which is used as a polyimide precursor.

In step (4), the inert gas comprises such as nitrogen, argon, and so on. Furthermore, the solvent (E) is not particularly limited as long as it can dissolve the polyamic acid, and an amide solvent is preferred. Specifically, the solvent (E) may be a polar solvent, a low boiling point solvent, or a low water absorption solvent. For example, the solvent (E) may be at least one selected from a group consisting of m-cresol, dimethylacetamide (DMAc), tetrahydrofuran (THF), N-methyl-2-pyrrolidone (NMP), N, N-Dimethylformamide (DMF), dimethylsulfoxide (DMSO), chloroform, 3-methoxy-N, N-dimethylpropionamide and γ-butyrolactone (GBL), but it is not limited thereto. One of them may be used alone or two or more of them may be used in combination according to requirements. The amount of solvent (E) is not particularly limited.

In one embodiment, the material of the solvent (E) is different from that of the solvent (A). For example, the solvent (E) is DMAc and the solvent (A) is m-cresol, so the color of the solvent (A) is darker than that of the solvent (E), but it is not limited thereto. Furthermore, in one embodiment, the solvent (E) is preferably composed of a transparent and colorless material, and preferably a material whose color is not too dark at high temperature, so as to avoid affecting the color of the retardation optical film formed subsequently.

In one embodiment, the molar ratio of the diamine monomer (B) to the dianhydride monomer (B) is 1:1, but it is not limited thereto. In order to obtain a polyamic acid solution with appropriate molecular weight and viscosity, relative to the solid content of the polyamic acid solution, the total solids content of the diamine monomer (B) and the dianhydride monomer (B) is preferably 10˜30 weight percent and more preferably 10˜20 weight percent.

In one embodiment, the diamine monomer (B) comprises one or more selected from a group consisting of an oxy group, a sulfo group, and a fluoro group. The diamine monomer (B) may be selected from a group consisting of 2,2′-bis(trifluoromethyl)diaminobiphenyl (TFMB), 3,4′-diaminodiphenyl ether, 4,4′-diaminodiphenyl ether, 4,4′-bis(3-aminophenoxy) diphenyl sulfone (m-BAPS), 4,4′-diaminodicyclohexyl methane, 4,4′-methylenebis(2-methylcyclohexylamine), 4,4′-(hexafluoroisopropylidene)bis(p-phenyleneoxy)dianiline, and 3,3′-dimethylbenzidine.

Furthermore, in one embodiment, the material of the diamine monomer (B) is different from that of the diamine monomer (A). For example, the diamine monomer (B) is TFMB, while the diamine monomer (A) is ODA, but it is not limited thereto. For example, in another embodiment, the material of the diamine monomer (B) may be the same as that of the diamine monomer (A).

In one embodiment, the dianhydride monomer (B) comprises one or more selected from a group consisting of an oxy group, a fluoro group, and an alicyclic group. For example, the dianhydride monomer (B) may be one or more selected from a group consisting of 4,4′-(hexafluoroisopropylidene)diphthalic anhydride (6FDA), 4,4′-oxydiphthalic anhydride (ODPA), 1,2,4,5-cyclohexanetetracarboxylic acid dianhydride (HPMDA), and cyclobutanetetracarboxylic dianhydride (CBDA), but it is not limited thereto.

Furthermore, in one embodiment, the material of the dianhydride monomer (B) is different from that of the dianhydride monomer (A). For example, the dianhydride monomer (B) is 6FDA, while the dianhydride monomer (A) is HPMDA, but it is not limited thereto. For example, in another embodiment, the material of the dianhydride monomer (B) may be the same as that of the dianhydride monomer (A).

Step (5): The polyamic acid solution in step (4) and the soluble polyimide solution in step (3) are mixed and continuously stirred to form a mixed solution.

In one embodiment, the total solids content of the soluble polyimide solution relative to the polyamic acid solution is 10˜50 weight percent, but it is not limited thereto. The total solids content of the soluble polyimide relative to the polyamic acid solution is 10˜50%. It can effectively reduce the retardation value by more than 40%, and the highest is 90%. It proves that this method can reduce the regularity of the molecular structure thereby achieving excellent retardation value.

Step (6): The mixed solution in step (5) is coated on a substrate, and heated at a suitable high temperature in a vacuum environment so that the coating layer on the substrate is cured to form a polyimide film as a retardation optical film.

In one embodiment, the above-mentioned substrate is a glass substrate or another suitable substrate. For example, a spin coating method, a bar coating method, a knife coating method, a roll coating method, a gravure coating method, or another suitable coating method can be used to coat the above-mentioned mixed solution. In one embodiment, the thickness of the polyimide film used as the retardation optical film is 10˜50 um, such as about 13 um or 25 um, but it is not limited thereto.

Since the polyimide fibers with high molecular weight are filtered out in step (3) (for example, the molecular weight of the filtered polyimide fibers is greater than 100,000), the obtained polyimide solution becomes low in molecular weight and soluble. In the film-forming process of the step (6), the soluble polyimide solution interferes with the molecular structure of the polyimide precursor and the regular arrangement is reduced. Therefore, the polyimide film obtained after curing can have the desired low retardation value.

Furthermore, when the meta-position dianhydride monomer is used as the diamine monomer (A), in the film-forming process of the step (6), the diamine monomer (A) with the meta position also affects the arrangement of the molecular structure of the polyimide precursor and further increase the random dispersion. In this way, the obtained polyimide film can have a more desirable low retardation value (for example, Rₜₕ is equal to or lower than 30 nm, but it is not limited thereto).

In the above-mentioned method for forming the retardation optical film, the molecular structure of the retardation optical film material is affected by adding a soluble polyimide with low molecular weight and/or containing a meta-position diamine monomer. The regularity of the arrangement of molecular segments is reduced in the film-forming process so that the formed retardation optical film has high transparency, desired low retardation value, and other optical properties. Therefore, this retardation optical film can be suitable for use in displays (for example, liquid crystal displays or various flexible displays), and can prevent the displays from rainbow patterns that affect visibility.

The specific embodiments of the method for forming the retardation optical film according to the invention are described in detail below, but the invention is not limited to the contents described in the following embodiments.

### Embodiment 1

Step (1): Under a nitrogen atmosphere, about 26.8 g of 3,4′-diaminodiphenyl ether (ODA) and 300 g of m-cresol solvent are added in a 500 ml three-necked flask, and stirred at 22° C. for 30 minutes. After the complete dissolution of ODA, about 30 g of 1,2,4,5-cyclohexanetetracarboxylic acid dianhydride (HPMDA) and about 21 g of m-cresol solvent are added, and the stirring is continued at 22° C. for 30 minutes. Then the temperature is raised to 90° C. and the stirring is continued for 3 hours. Finally, the temperature is raised to 180° C. and the stirring is continued for 16 hours.

Step (2): The temperature is reduced to room temperature, about 180 g of m-cresol solvent is added, and stirring is continued for 30 minutes. The diluted slurry was gradually dripped into 800 ml of methanol solution to form long strips of fine polyimide fibers. The fibers are thoroughly washed with a new methanol solution to remove the residual m-cresol solvent. Finally, drying was carried out in a vacuum oven at 150° C. for 24 hours.

Step (3): About 40 g of dried fibers and about 120 g of tetrahydrofuran are added to a 250 ml beaker and stirred for 12 hours. 1 um filter paper is then used to filter so as to obtain a clear and transparent soluble polyimide slurry for subsequent use.

Step (4): Under nitrogen atmosphere, about 14.4 g of 2,2′-bis(trifluoromethyl)benzidine (TFMB) and about 137.7 g of dimethylacetamide (DMAc) are added in a 250 ml three-necked flask, and stirred at 22° C. for 30 minutes. After the TFMB is completely dissolved, about 20 g of 4,4′-(hexafluoroisopropylidene)diphthalic anhydride (6FDA) is added and the stirring is continued at 22° C. for 24 hours.

Step (5): 30 g of the slurry of the step (4) is added in three 100 ml glass bottles. Then, the slurry of the step (3) in proportions of 10%, 30%, and 50% are added respectively in these three glass bottles, and the stirring is continued for 30 minutes. These sample codes are OCP 10%, OCP 30% and OCP 50%.

Step (6): The slurry of OCP 10%, OCP 30%, and OCP 50% is coated on a glass plate, and heated in a vacuum oven at 250° C. for 60 minutes, thereby allowing the coated slurry cured to form a polyimide film.

Table 1 is the optical property evaluation data of the polyimide film formed according to Embodiment 1 of the method for forming a retardation optical film disclosed in the invention. As seen from Table 1, the Rₜₕ value of the sample CP without adding soluble polyimide (SPI) is about 183.89 nm, while the Rₜₕ value of the samples formed by adding the soluble polyimide (OCP 10%, OCP 30%, and OCP 50%) is significantly reduced to 58˜105 nm. The reduction ratio reaches 42%˜68%. Therefore, in addition to the low retardation, the optical properties of the polyimide film formed by adding the soluble polyimide have not been significantly reduced, and are also more excellent than the optical specifications required for optical films (transmittance≥90%, haze≤1, b*<1).

TABLE 1
Optical property evaluation data of Embodiment 1

| | Soluble | | | | | | |
|---|---|---|---|---|---|---|---|
| | SPI | | Retardation value | | Total light | | |
| Sample | Content | Thickness | (nm) | | transmittance | Haze | Chromaticity |
| code | (%) | (um) | R₀ | Rₜₕ | (%) | (%) | (L*/a*/b*) |
| CP | 0 | 13 | 0.138 | 183.891 | 91.63 | 0.46 | 96.53/−0.02/0.41 |
| OCP10 % | 10 | 13 | 0.143 | 105.475 | 91.59 | 0.44 | 96.50/−0.03/0.41 |
| OCP30 % | 30 | 13 | 0.155 | 73.322 | 91.48 | 0.56 | 96.45/−0.02/0.42 |
| OCP50 % | 50 | 13 | 0.168 | 58.219 | 91.41 | 0.57 | 95.44/−0.03/0.45 |

CP = 6FDA:TFMB (1:1)

### Embodiment 2

Step (1): Under a nitrogen atmosphere, about 38.59 g of 4,4′-bis(3-aminophenoxy) diphenyl sulfone (m-BAPS) and about 300 g of m-cresol solvent are added in a 500 ml three-necked flask, and stirred at 22° C. for 30 minutes. After the complete dissolution of m-BAPS, about 20 g of 1,2,4,5-cyclohexanetetracarboxylic acid dianhydride (HPMDA) and about 32 g of m-cresol solvent are added, and the stirring is continued at 22° C. for 30 minutes. Then the temperature is raised to 90° C. and the stirring is continued for 3 hours. Finally, the temperature is raised to 180° C. and the stirring is continued for 16 hours. In addition, a chemical imidization method can also be used to imidize m-BAPS and HPMDA in the m-cresol solvent.

Steps (2)˜(6): In Embodiment 2, except that the code name of the samples in steps (5) and (6) are changed to SCP 10%, SCP 30%, and SCP 50%, respectively, the steps (2)˜(6) are substantially the same as those steps (2)˜(6) of Embodiment 1, so the details are not repeated herein.

Table 2 is the optical property evaluation data of the polyimide film formed according to Embodiment 2 of the method for forming a retardation optical film disclosed in the invention. As seen from Table 2, the Rₜₕ value of the sample CP without adding soluble polyimide is about 183.89 nm, while the Rₜₕ value of the samples formed by adding the soluble polyimide (SCP 10%, SCP 30%, and SCP 50%) is significantly reduced to 18˜92 nm. The reduction ratio reaches 49%˜90%. Therefore, in addition to the low retardation, the optical properties of the polyimide film formed by adding the soluble polyimide are also more excellent than the optical specifications required for optical films (transmittance≥90%, haze≤1, b*<1).

TABLE 2
Optical property evaluation data of Embodiment 2

| | Soluble | | | | | | |
|---|---|---|---|---|---|---|---|
| | SPI | | Retardation value | | Total light | | |
| Sample | Content | Thickness | (nm) | | transmittance | Haze | Chromaticity |
| code | (%) | (um) | R₀ | Rₜₕ | (%) | (%) | (L*/a*/b*) |
| CP | 0 | 13 | 0.138 | 183.891 | 91.63 | 0.46 | 96.53/−.02/0.41 |
| OCP10 % | 10 | 13 | 0.123 | 92.418 | 91.46 | 0.54 | 96.48/−.02/0.47 |
| OCP30 % | 30 | 13 | 0.227 | 48.590 | 91.41 | 0.52 | 95.89/−.01/0.62 |
| OCP50 % | 50 | 13 | 0.145 | 18.012 | 91.11 | 0.55 | 95.11/−.01/0.85 |

CP = 6FDA:TFMB (1:1)

Since the molecular structure of polyimide itself has more benzene ring structures, after it is coated and dried to form a retardation optical film, the film has optical anisotropy, resulting in retardation characteristics. In Embodiment 1 and Embodiment 2, the molecular structure of the polyimide film is changed by adding a soluble polyimide with low molecular weight and/or containing a meta-position diamine monomer to reduce the regular arrangement of molecules. Then the polarization state of the transmitted light is modified, and the degree of polarization is reduced. It can effectively eliminate the rainbow patterns caused by birefringence, and reduce the interference on the display.

Furthermore, as seen from Tables 1 and 2, in Embodiment 1, a soluble polyimide containing 3,4′-diaminodiphenyl ether (ODA) is added to reduce the Rₜₕ value to 105˜58 nm, while maintaining good optical properties. And in Embodiment 2, a soluble polyimide containing 4,4′-bis(3-aminophenoxy) diphenyl sulfone (m-BAPS) is added to reduce the Rₜₕ value to 18˜92 nm, while maintaining good optical properties. The reduction degree of the Rₜₕ values is different between Embodiment 1 and Embodiment 2. There are two main reasons, (1): the sulfur (—S—) segment in the structure of 4,4′-bis(3-aminophenoxy) diphenyl sulfone (m-BAPS) is more flexible than the oxygen (—O—) segment in the structure of 3,4′-diaminodiphenyl ether (ODA). It can increase the rotation of molecular segments, thereby reducing the regular arrangement of molecular segments. (2): The structure of the meta position can effectively make the molecular segments form asymmetric. In view of the above two reasons, it can further increase the dispersibility of the molecular segments of polyimide during the process of baking to form a film, thereby significantly affecting the degree of reduction of the Rₜₕ value. In this way, besides adding the soluble polyimide with low molecular weight, if this soluble polyimide also contains a meta-diamine monomer, the regularity of the molecular structure is greatly changed. It can further reduce the retardation (For example, the retardation value Rₜₕ is less than 20 nm), allowing the effect of preventing birefringence which causes rainbow patterns in the invention becomes more excellent.

1. A method for forming a retardation optical film, comprising:
adding a diamine monomer (A) and a dianhydride monomer (A) in a solvent (A) to react to form a polyimide slurry;
adding the polyimide slurry into a solvent (B) to precipitate out a plurality of polyimide fibers;
washing the plurality of polyimide fibers with a solvent (C);
mixing the plurality of polyimide fibers with a solvent (D) to obtain a soluble polyimide solution;
reacting a diamine monomer (B) and a dianhydride monomer (B) to form a polyamic acid solution;
coating a mixed solution including the soluble polyimide solution and the polyamic acid solution on a substrate; and
heating to form a retardation optical film made of polyimide on the substrate.

2. The method for forming a retardation optical film of claim 1, wherein the solvent (C) removes the solvent (A) remaining in the plurality of polyimide fibers.

3. The method for forming a retardation optical film of claim 1, wherein a material of the solvent (C) is same as a material of the solvent (B).

4. The method for forming a retardation optical film of claim 1, wherein a solubility of the solvent (D) is lower than a solubility of the solvent (A).

5. The method for forming a retardation optical film of claim 1, further comprising:
after mixing the plurality of polyimide fibers with the solvent (D), filtering to obtain the soluble polyimide solution, wherein the plurality of polyimide fibers filtered out has a molecular weight greater than 100,000.

6. The method for forming a retardation optical film of claim 1, wherein during the washing of the plurality of polyimide fibers with the solvent (C) to remove the solvent (A), a color of the plurality polyimide fibers becomes lighter.

7. The method for forming a retardation optical film of claim 1, wherein a total solids content of the soluble polyimide solution relative to the polyimide solution is 10˜50 weight percent.

8. The method for forming a retardation optical film of claim 1, wherein the diamine monomer (A) comprises one or more selected from a group consisting of 3,4′-diaminodiphenyl ether and 4,4′-bis(3-aminophenoxy) diphenyl sulfone.

9. The method for forming a retardation optical film of claim 1, wherein the diamine monomer (A) is a meta-dianhydride monomer.

10. The method for forming a retardation optical film of claim 1, wherein the dianhydride monomer (A) comprises one or more selected from a group consisting of 1,2,4,5-cyclohexanetetracarboxylic acid dianhydride and tetrahydro-5,9-methano-1H-pyrano[3,4-D] oxazepine-1,3,6,8(4H)-tetraketone.
